(19) United States
(12) Patent Application Publication
(10) Pub. No.: US 2021/0347500 A1
(43) Pub. Date: Nov. 11, 2021

(54) DRONE DOCKING SYSTEM

(71) Applicant: Chris HAGAN, Southport, Merseyside (GB)

(72) Inventor: Chris HAGAN, Southport, Merseyside (GB)

(21) Appl. No.: 17/281,169

(22) PCT Filed: Aug. 9, 2019
(86) PCT No.: PCT/GB2019/052235

§ 371 Date: Mar. 29, 2021

(30) Foreign Application Priority Data
Aug. 10, 2018 (GB) 1813056.7
Jun. 25, 2019 (GB) 1909150.3

(51) Int. Cl. B64F 1/22; B64C 39/02; B64C 27/20

(52) U.S. Cl. CPC B64F 1/222; B64F 1/18; B64C 27/20; B64C 39/024

(57) ABSTRACT

A drone docking system (10) for multicopter drone (50) comprises a docking station (20) having a receiver (26). The CT receiver (26) is adapted to connect to a docking formation (52) mounted atop the drone (50) such that when the drone (50) is docked with the docking station (20), the drone (50) is suspended from and below the docking station (20). A fail-safe mechanical connection (56, 32) is provided to connect the docking formation (52) to the receiver (26). One or more electromagnets (34, 58) may be used to NI connect the docking formation (52) to the receiver (26), which electromagnets (34, 58) are suitably controllable to provide a smooth transition between docked and free-flight states of the drone (50) and optionally to guide the docking formation (52) into alignment with the receiver (26). The drone (50) suitably has a payload rendering it useful for surveillance and crime prevention/detection purposes.

### CROSS REFERENCE TO RELATED APPLICATIONS

This application is a national phase filing under 35 U.S.C § 371 of International Application No. PCT/GB2019/052235, filed on Aug. 9, 2019, which claims the benefit of GB Application No. 1909150.3, filed on Jun. 25, 2019, and GB Application No. 1813056.7, filed on Aug. 10, 2018, the entire disclosures of which are incorporated by reference herein.

This invention relates to a drone docking system.

Drones, that is to say, remotely-operated or autonomous flying machines or UAVs (Unmanned Aerial Vehicles), are an established technology, and are nowadays used in a range of surveying/surveillance applications. Drones are often fitted with cameras and other equipment, such as LIDAR scanners, payload bays, robotic limbs, etc. that enable them to carry out a range of aerial work.

Most drones are of the multicopter type, that is to say, having a main fuselage portion with limbs extending laterally therefrom. Each limb carries, at its distal end, a rotor/propeller which provides a lift thrust to hold the drone aloft. The drone can be controlled in the pitch, yaw, roll, X, Y, and Z axes by controlling the relative speeds of the rotors, and/or in certain cases, by vectoring the rotors. Other types of drone or remotely-operated aerial vehicle exist, such as balloon/blimp and fixed-wing drones (i.e. of an aeroplane type), which are generally used for longer-range operations. This invention is primarily concerned with multicopter type drones.

Known docking systems are described in: KR1020170104186 [KIM], EP3492379 [POLITECHNIKA], and KR1020180029676 [UNIV KYUNGHEE].

When a multicopter type drone is not in use, it is useful and/or convenient for it to be stowed on a “launch pad” or “docking” type device. This is typically a platform upon which the drone can be landed, or placed upon, which provides protection for the drone, as well as certain other functions, such as charging. Certain practical advantages are thus gained by flying the drone from, and returning it to, its launch pad. For example, it is possible to house a drone in/on a remote launchpad, away from an operator of the drone, which can be useful where multiple, spaced-apart drones are used for surveillance purposes.

However, a problem that exists with conventional drone/launchpad technology is the vulnerability of the drone to vandalism, theft and/or sabotage whilst the drone is docked with its launch pad. The reason for this is that the launchpad is typically located at ground level, and the drone is usually in a “sleep” state whilst docked. It is possible to elevate a known launchpad, to make it more inaccessible, but this can have adverse consequences, such as reduced accessibility for legitimate purposes, unsightliness, and increased conspicuity, which detracts from the covert nature of many drone installations. Elevated launch pads also tend to be more susceptible to weathering and can be more difficult to access for maintenance purposes.

A need therefore exists for a solution to one or more of the above problems and/or for an improved and/or alternative drone system.

Aspects of the invention are set forth in the appended independent claims. Preferred and/or optional features of the invention are set forth in the dependent claims.

The invention differs from known drone systems insofar as the drone is suspended from, rather than supported from below by, its docking station.

Conventional wisdom dictates that the drone is flown up off its docking station due to the fact that drone becomes airborne by increasing its lift. The known configuration dictates a certain amount of vertical clearance above the docking station for the drone to be able to fly up and away from the docking station.

In the case of the present invention, however, the drone is initially suspended below the docking station, and so flight begins by the drone initially dropping away from the docking station. This has a number of technical implications, such as safeguarding against a failure of the drone to generate sufficient lift to support its weight prior to being released from the docking station. As such the proposed configuration is counterintuitive.

To address this issue, the invention proposes using a receiver for releasably receiving the docking formation.

In certain embodiments of the invention, the mechanical engagement device comprises a plurality of pivotally mounted hooks, which engage with an abutment. The hooks may be provided on the docking station and the abutment on the drone, or vice versa. Suitably, the range of motion of the hooks is constrained in a first direction by an abutment, but the hooks are free to pivot away from the abutment in a second direction opposite the first. The mechanical engagement device works by virtue of the fact that the abutment is moveable relative to the hooks by virtue of the relative movement of the drone and docking station. As such, during movement of the abutment in a first direction, the abutment can move (e.g. push) the hooks away from the abutment so that they eventually pass by the abutment and the hooks can then move in the first direction, for example, by gravity. Then, when the abutment (drone) is moved in an opposite direction, the hooks have moved to a position whereby they engage the abutment and prevent further movement of the drone from the docking station.

An advantage of this type mechanical engagement is that when the drone is engaged with the docking station, gravity acts to hold the abutment in engagement with the hooks. This safeguards against the possibility of the drone becoming undocked from the docking station accidentally because the default configuration is for the drone to be positively engaged with the docking station. However, the hooks can be moved to a disengaging position, for example by using an actuator, such that the hooks disengage from the abutment and release the drone from the docking station. This shall be described in greater detail later on.

Additionally or alternatively, the mechanical engagement device may comprise a plurality of hooks, which have shafts and hook portions extending radially from the shafts. Rotation of the shafts enables the hook portions to be moved between different positions so that they can either engage, or not engage, an abutment on demand. Thus, rotation of the shafts of the hooks causes the hook portions to either engage or disengage, and this can be achieved using a motor system, such as described later with reference to the drawings.

In certain other embodiments of the invention, the receiver may comprise a catch-type device, such as one or more solenoid-controlled or solenoid-activated pins, which selectively engage/disengage a complementary part of the docking formation. Suitably, the complementary part of the docking formation comprises a groove extending around a perimeter of the docking formation, which a solenoid-actuated pin or a set of solenoid-actuated pins can selectively engage or disengage. When the solenoid-actuated pin or pins are engaged with the groove, the weight of the drone is supported by the docking station via the pins, but when the pin or pins are disengaged from the groove, i.e. retracted, the drone is released from the docking station.

Preferably, the pin or pins are biased towards an engaging position, such as by being spring- loaded. In other words, the solenoid needs to be energised to retract the pins, but when it is de- energised, the pins spring back into an engaging position. This configuration safeguards against a power loss by ensuring that in the event of power loss, the pins engage the drone, rather than retract, thereby releasing it.

In other embodiments of the invention, a similar configuration to that described immediately above is proposed, except that rather than the pins of the solenoids engaging the docking formation directly, the solenoids act upon a plurality of split-plates, which engage the docking formation. Other means for actuating the split-plates may be used, other than solenoids, such as cams, linear actuators, screw threads, etc.

Additionally or alternatively, the docking formation comprises a metal plate, and the receiver may comprise a magnet. Suitably, the magnet is an electromagnet, which, when energised, attracts and retains the metal plate of the docking formation, but which when de-energised, releases the metal plate of the docking formation, thereby releasing the drone from the docking station.

In a preferred embodiment of the invention, both a magnetic and a mechanical connection is provided between the docking formation and the receiver, which can be used together, or sequentially. For example, during a docking/undocking procedure, the mechanical connection can be disengaged enabling retention of the drone within the docking station to be accomplished by the energisation state of the electromagnet.

It will be appreciated, by the skilled reader, that during the initial phases of flight, there is a transition period where the weight of the drone is greater than the lift generated by the rotors, before such time as the rotors are generating sufficient lift to hold the drone in a hover or climbing configuration. Rather than simply releasing the drone from the docking station, the invention is suitably configured such that the amount of force exerted on the drone by the docking station is proportional to the amount of lift generated by the drone. This enables a gradual transition between the drone being supported by the docking station, and the drone supporting its own weight using its rotors.

This can be advantageous because the magnetic force can be reduced to gradually release the drone from the docking station, for example, in proportion to the amount of lift generated by the drone as its rotors spin-up. Conversely, the electromagnetic force can be ramped-up as the drone docks, thereby permitting a more controlled and/or gradual engagement of the drone with the docking station. Once docked, the mechanical connection can be engaged and the electromagnet deenergised, thereby conserving power.

Moreover, the solenoid-actuated locking pins or split-plates could be biased towards a drone- engaging position, for example, using a spring, such that the pins are retracted (the drone disengaged) when the solenoid or other separating device is deenergised. Thus, the zero- or low-power state of the mechanical engagement is such that the drone is engaged, which means that power does not need to be consumed to retain the drone within its docking station.

An additional benefit of using spring-loaded locking pins or split-plates is that they can act as a catch to clip into the groove or other formation as the drone is docked. Thus, power only needs to be applied to the solenoid briefly to disengage the drone from the docking station, thereby further conserving power.

Suitably, the receiver and docking formation are tapered, so as to centralise the drone with the docking station as it is docked. This configuration may also assist with the spring-loaded pin catch mechanism outlined in the preceding paragraph.

Because the invention, in certain embodiments, uses an electromagnet to engage the drone with the docking station, the magnetic field can also be used to assist in the docking of the drone. By appropriately configuring the coils and ferromagnetic element(s) of the electromagnet, it is possible to create a magnetic field having a profile that tends to centralise the drone with the docking station. This can help to counteract errors in the alignment of the drone relative to the docking station during a docking and/or undocking procedure. Moreover, because the magnetic field is “contactless”, until such time as the drone actually docks with the docking station, the magnetic field profile could be adjusted dynamically to pull or push the drone left/right/up/down as required to assist in correctly docking the drone with the docking station.

It will be appreciated that if the drone is released from the docking station before it has generated sufficient lift, that the drone may fall away in an uncontrolled manner.

Certain drones are pre-configured to have an “autosave” function, which generally comprises an accelerometer and an orientation sensor which detects when the drone is in freefall. When a freefall condition is detected, many drones have software/control systems that automatically power- up the rotors so that the drone adopts a hover flight configuration, and in certain embodiments, this functionality could be used to launch the drone. For example, the docking station could simply “release” the drone, which drops under the force of gravity. The freefall is then detected by the drone's sensors and the drone automatically takes flight and the “launch” of the drone is effectively from the point where it has stabilised itself automatically.

However, means is preferably provided for delaying the complete release of the drone from the docking station until such time as the drone has generated sufficient lift to support its own weight. This may be accomplished in a variety of ways.

In one embodiment, a force-sensing device is interposed between the receiver and docking formation, which is adapted to sense the force (weight) imparted by the drone on the docking station. When the drone is generating less lift than its weight, a net downward force may be detected, or vice- versa. A controller is suitably used to control the releasing of the drone from the docking station, which is suitably configured to retain the drone when the measured net downward force is greater than a specified value, which may be zero, or substantially zero. A feedback or control circuit may be provided, in certain embodiments, to balance the detected down force with the current in the electromagnet (where provided), i.e. the magnetic force used to retain the drone within the docking station. This can be used to ensure a smooth transition between the supported (docked) state of the drone and a free-flight state of the drone.

Additionally or alternatively, a rotor speed sensor may be provided for sensing the speed of the drone's rotor or rotors. There will inevitably be a relationship between the drone's rotor speed(s) and the resultant lift force, so when the rotors are spinning at greater than a specified RPM, it can be assumed that the drone able to support its own weight. A controller may therefore be provided, which releases the drone from the docking station, when the specified minimum RPM is measured at one or more of the drone's rotors.

It will be appreciated by the skilled reader that a fail-safe is suitably provided to prevent the drone from falling from the docking station in the event of a malfunction. Any suitable means may be provided for this, such as a catch net or shelf located below the docking station, such that in the event of a docking malfunction, the drone cannot simply fall to the floor, but is caught before any significant damage to the drone and/or the surrounding area can be caused.

Preferably, an active supplementary restraint system is provided, which could, in certain embodiments, comprise a set of elasticated bands extending underneath the drone when it is in the docking station. Suitably, the elasticated bands are retracted, for example by using a winch or other device such as an electromagnet, so that the elasticated bands are ordinarily pulled out of the way of the drone to enable it to fly away. However, in the event of a malfunction, the retraction of the elasticated bands can be released such that they span the underside of the docking station to catch the drone should it fall from the docking station during a malfunction. This shall be elucidated in greater detail below.

The drone suitably carries a payload. The payload may comprise any one or more of:
A surveillance camera, such as a CCTV camera, an IR/night vision camera, a thermal imaging camera, a LIDAR device, etc., which is suitably a video camera, and is which preferably remotely operable to pan/tilt/zoom in accordance with cameral control instructions, which may be generated by a human operative or pilot, or by a computer system.
A public address system, such as a speaker, which enables a pilot/operator/computer system to broadcast voice and/or pre-recorded messages to people in the vicinity of the drone.
A tracking system, which may be a SmartWater® deployment/jetting system, which is able to deposit/spray SmartWater® from the drone onto people or objects below.

To protect the drone when it is docked, the docking station suitably comprises an outer housing, which hangs down from the docking station providing a curtain around the drone when it is docked. The outer housing naturally has an opening on its underside, to enable the drone to fly into and/or out of the docking station from below.

Preferably, the underside of the docking station has formations to permit airflow into and out of it, which may be necessary to generate lift and/or stable flight characteristics of the drone during the docking/undocking procedure. In one possible embodiment, a part-toroidal cavity is provided on the underside of the docking station, which permits/directs air to flow smoothly into the docking station, through the drone's rotors and back out again.

The drone suitably comprises a bumper system to protect its fuselage, empennage and/or rotors from impacts with objects, including the docking station. The bumper system suitably comprises a lightweight (e.g. plastics) mesh, which surrounds vulnerable parts of the drone, such as its rotors. Because the mesh is reticulated, it enables relatively uninhibited airflow through it, which reduces the effects of turbulence/obstruction in the airflow to/from the rotors.

Additional protection devices may be provided for the drone, such as a BRS (Ballistic parachute Recovery System), which can be deployed in the event of the drone's functionality being compromised during flight. The BRS system suitably deploys a drogue or parachute, should the drone malfunction in flight, which enables the drone to descend to the ground in a controlled and/or non-damaging manner.

Preferred embodiments of the invention shall now be described, by way of example only, with reference to the accompanying drawings, in which:

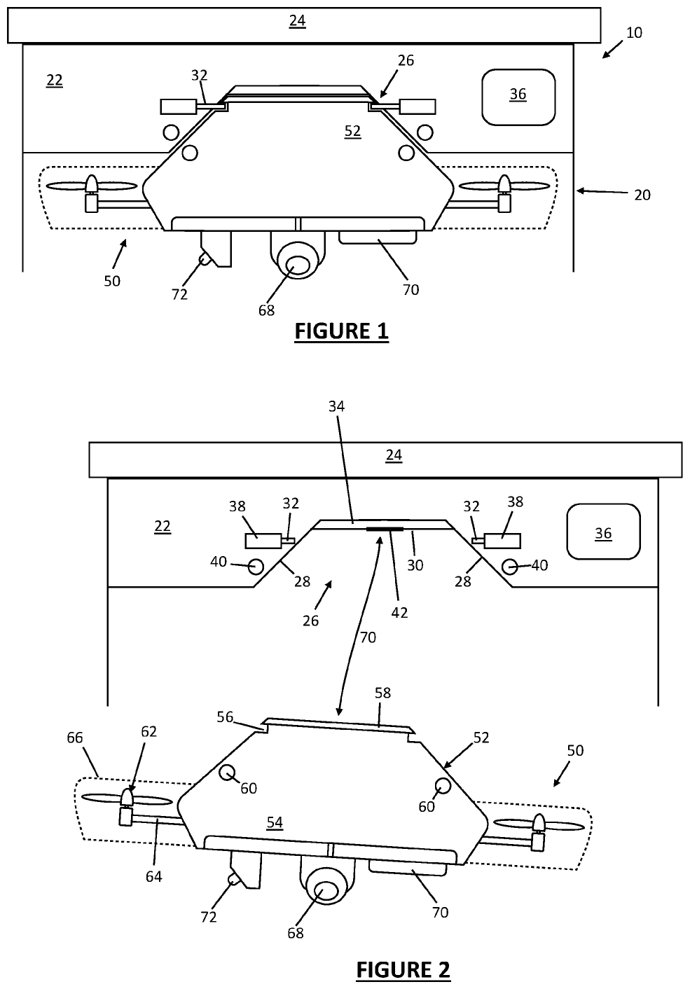

FIG. 1 is a schematic cross-sectional view of an embodiment of a drone system in accordance with the invention, with the drone docked;

FIG. 2 is a schematic cross-sectional view of the embodiment of the drone system of FIG. 1, with the drone un-docked;

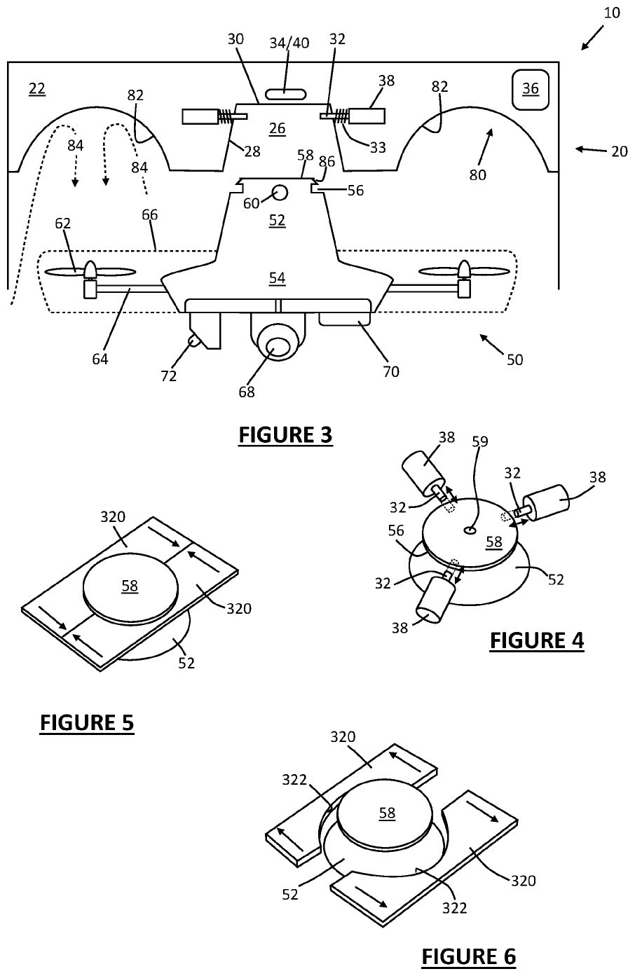

FIG. 3 is a schematic cross-sectional view of a variation of the embodiment shown in FIG. 2, with the drone docked;

FIG. 4 is a partial perspective view of the docking formation shown in FIG. 3;

FIGS. 5 and 6 are a sequence showing how split plates can be used to engage/disengage the drone;

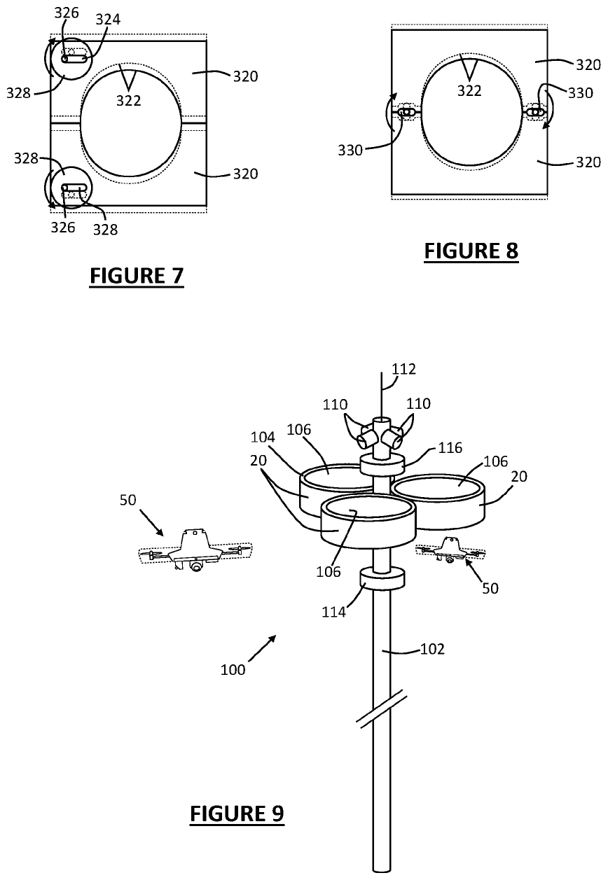

FIGS. 7 and 8 show alternative actuation mechanisms for the split-plates shown in FIGS. 5 and 6;

FIG. 9 is a schematic perspective view of a remote, autonomous sentry tower incorporating several drone systems according to the invention;

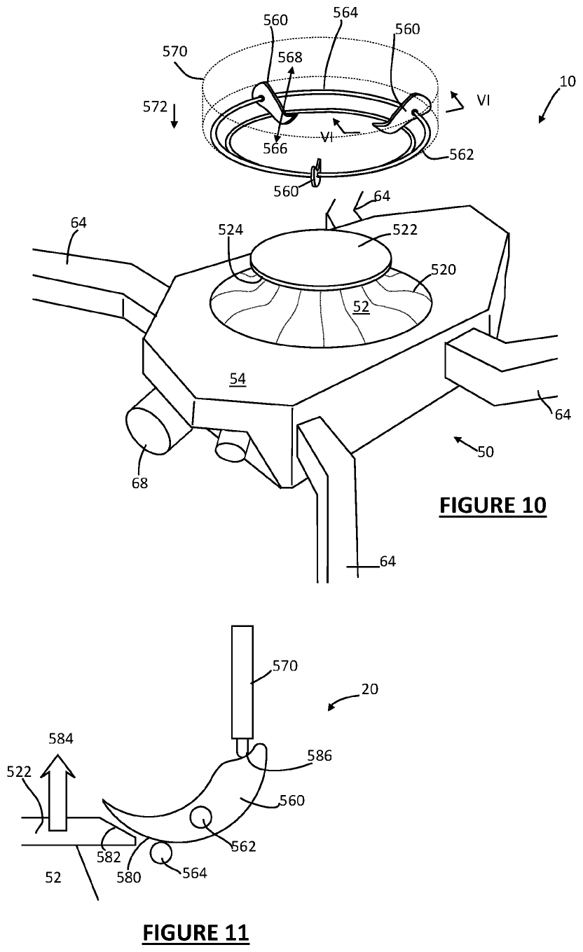

FIG. 10 is a schematic, perspective view of a possible mechanical engagement system for a drone docking system in accordance with the invention;

FIG. 11 is a schematic cross-section of FIG. 5 on the VI-VI;

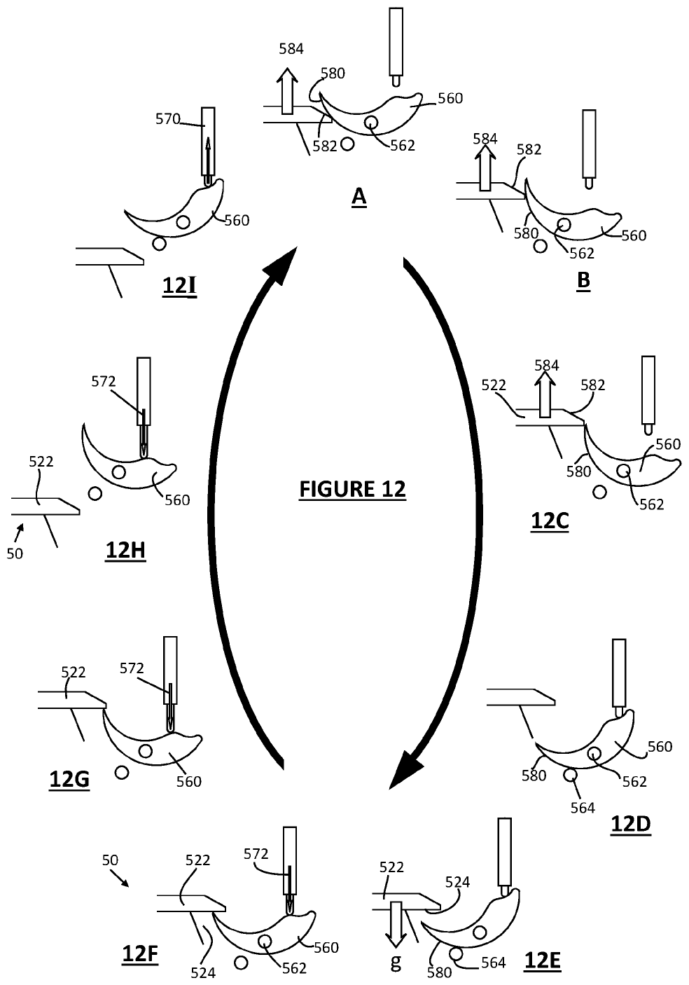

FIG. 12 is a schematic sequence showing an engagement and disengagement sequence of the mechanical locking system shown in FIGS. 5 and 6;

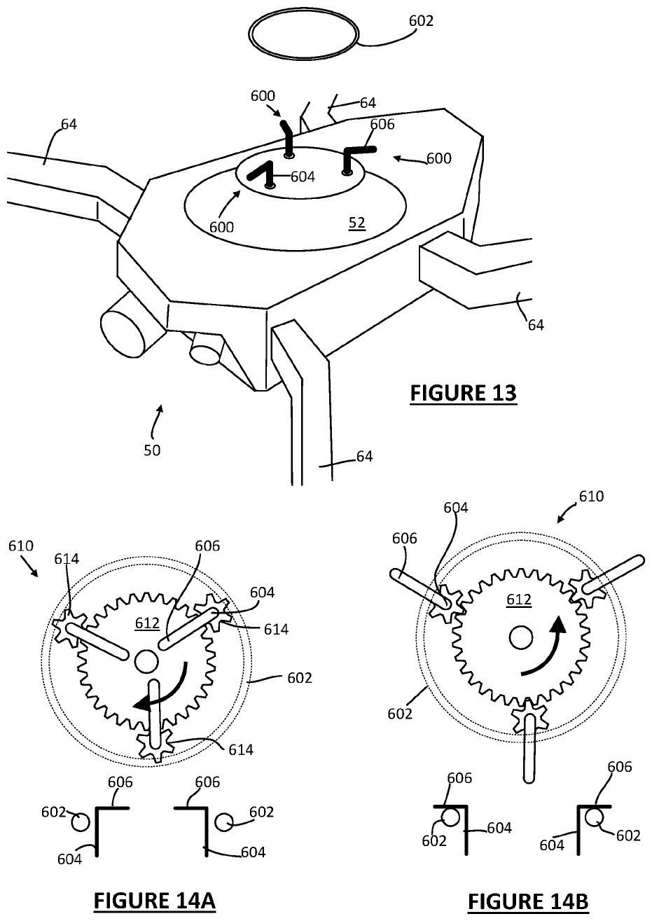

FIG. 13 is a schematic, perspective view of an alternate mechanical engagement device for a drone docking system in accordance with the invention;

FIGS. 14A and 14B show the mechanical engagement device of FIG. 8 in unlocked and locked configurations, respectively;

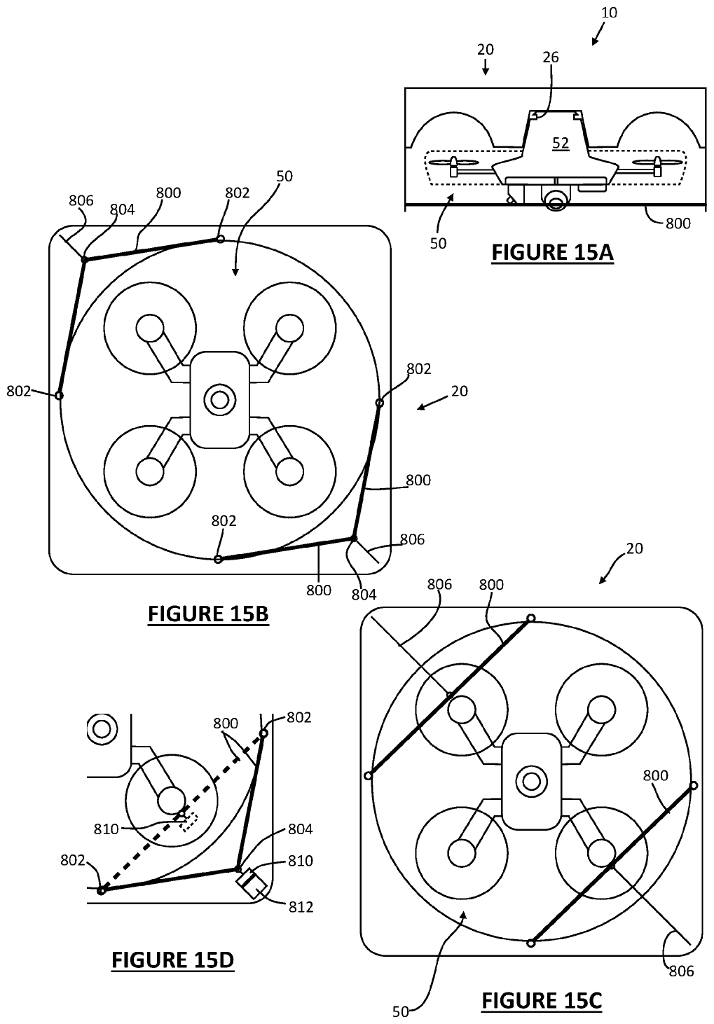

FIG. 15A is a schematic sectional view of a drone docking system in accordance with the invention comprising a supplementary restraint system;

FIGS. 15B and 15C are schematic underside views of the drone docking system of FIG. 10A in the unrestrained and restrained configurations respectively;

FIG. 15C shows an alternate restraint for the bands shown in FIGS. 15A, 15B and 15C;

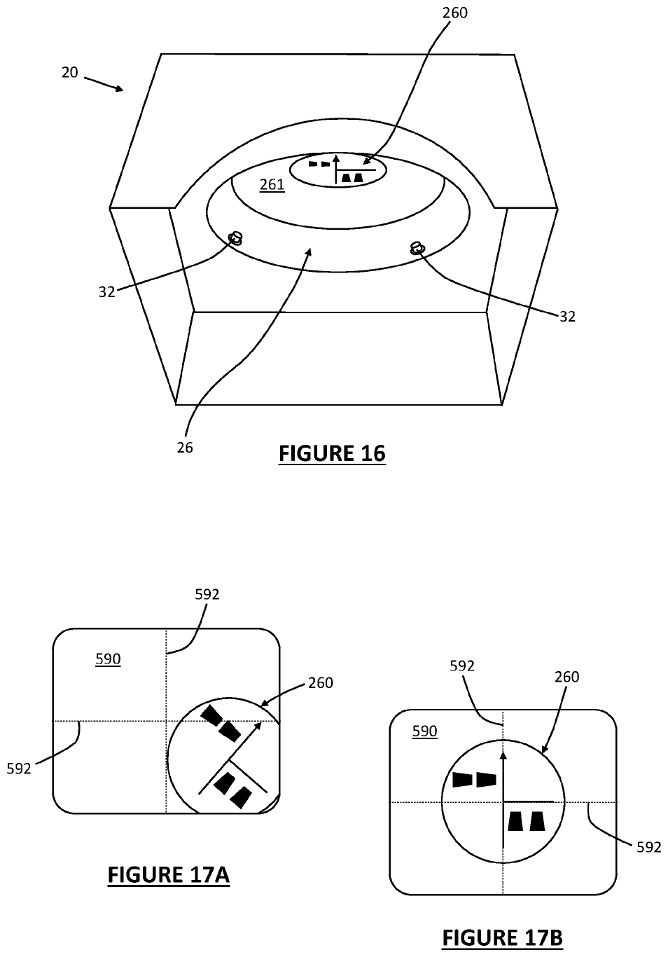

FIG. 16 is a schematic, perspective, partially cut-away view of an embodiment of the docking station 20 from below; and

FIGS. 17A and 17B are schematic illustrations of the field of view of an upward-facing camera fitted to the drone.

Referring to FIGS. 1, 2 and 3 of the drawings, the drone system 10 comprises a docking station 20 and a drone 50.

The docking station 20 comprises a main body portion 22, formed as a hollow housing, which is affixed, in use, for example, to soffit 24 of a building. The main body portion 22 has a truncated- conical hollow formed in its underside, which is a receiver 26 for the drone 50. The receiver 26 has inwardly tapered side walls 28, leading to a generally flat upper wall 30, thereby providing a “centraliser” function for the complementarily-shaped docking formation 52 of the drone 50.

The drone 50 has a main body (fuselage) 54, the upper part of which is the aforesaid docking formation 52. The docking formation 52 has a circumferential groove 56 formed near to its top, which is selectively engaged by locking pins 32 formed in the receiver 26. The top of the docking formation 52 is formed by a circular metal plate 58, that is selectively attracted to an electromagnet 34 provided within the main body 22 of the docking station 20, above the flat surface 30 of the receiver 26. A controller 36 is provided in the docking station 20 for controlling the operation of, inter alia, solenoids 38 that move the locking pins 32 and/or the electromagnet 34.

An induction charging coil 40 is also provided within the docking station, for wirelessly recharging a battery (not shown) of the drone 50. The drone 50 has a complementary induction charging coil 60, which picks-up the charge from the docking station 20, when docked therewith.

A force sensor 42 is provided, for sensing the force between the drone 50 and the docking station 20.

The drone also has a set of motor-driven rotors 62, which are mounted at distal ends of arms 64 extending laterally from the fuselage 54. A reticulated, plastics bumper 66 is provided, which surrounds the rotors 62 and protects them from impacts with foreign objects.

The drone 50 carries a payload, which comprises a moveable video camera 68, a public address speaker 70, and a SmartWater® deployment nozzle 72.

The drone is suitably waterproof, e.g. Ingress Protection (IP) rated, preferably up to IP68, and is preferably designed to float in water. This protects the drone from weather conditions, and also enables the drone to be recovered from bodies of water in the event of a crash.

The drone 50 can be launched by powering it up, providing power to the rotors 62 and accelerating them to produce lift. The force sensor 42 and/or a rotor speed sensor (not shown) are used to determine when the drone 50 has developed sufficient light to support its own weight. When this occurs, the electromagnet 34 can be gradually powered down or switched off and/or the locking pins 32 retracted using the solenoids 38 to release the drone 50 from the docking station 20. The drone 50, can then fly down and away 70 from the docking station 20 to perform a mission.

In certain applications, the launching of the drone 50 may be triggered by detection of an intruder. The drone 50 therefore flies to the location of the suspected intruder, and the camera 68 is used to capture video surveillance footage. If an intruder is identified, the PA system 70 can be used to speak to the suspected intruder and/or issue audible warnings. If necessary, objects or people can be sprayed, using the on-board nozzle 72, with SmartWater® to assist in tracking/crime detection.

At the end of the mission, the drone 650 returns to the docking station 20. As it approaches the docking station 20, the docking formation 52 begins to nest within the receiver 26 of the docking station. Due to the tapered sidewalls of the docking formation 52 and the receiver 26, the drone 50 self-centralises on the receiver 26, until is fully-home.

Referring to FIG. 3 of the drawings, which shows a slight variation of the drone system 10 previously described, the docking formation 52 in this embodiment is more up an extended truncated cone shape than in the previous embodiment, but otherwise, the drone 12 is largely as previously described.

The docking station 20 shown in FIG. 3 additionally comprises a fairing 80, which as a part- toroidal cavity 82 formed therein. This facilitates the flow of air 84 into and out of the housing during the drone's 20 docking and undocking procedure.

Further, it will be noted that the locking pins 32 are spring-loaded 33 so as to bias them towards an extended (locking) position. As the drone 50 engages with the docking station 20, a chamfered part 86 of the docking formation 52 urges the locking pins 32 apart until they align with the groove 56, whereupon the spring 33 force causes the drone 50 to click into engagement with the docking station. Thus, the solenoids 38 only need to be energised to release the drone 50 from the docking station 20, which conserves power.

As previously described, the electromagnet 34 can be pre-energised as the drone 50 approaches the docking station 20. The magnetic field produced by the electromagnet 34 can be used to assist in centralising the docking formation 52 with the receiver 26. In certain embodiments of the invention, several electromagnets are provided, which are independently controllable. By varying the relative currents in the electromagnets, the drone 50 can be pulled left/right/up/down relative to the docking station to assist in correcting any drift or errors in the docking procedure. It will also be appreciated, by the skilled reader, that the magnetic field decreases with distance from the electromagnet and this magnetic field decay effect can also be used to self-centralise the drone 50 within the docking station 20.

FIG. 4 of the drawings shows the solenoid 38 actuated pins 32 arranged 120-degrees apart around the docking formation 52 of the drone. It can be seen, by the dashed lines, that when the solenoids 38 are de-energised, the locking pins 32 project forwards into the groove 56 under the plate 58. However, when the solenoids 38 are energised, the locking pins 32 retract such that the outer periphery of the plate 58 clears the tips of the pins 32, enabling the drone to fly away and/or be released. Also shown in FIG. 4 is an upward-facing camera 59 located at the centre of the plate 58, whose function shall be described later with reference to FIGS. 17 and 18 hereinbelow.

FIGS. 5 and 6 of the drawings show alternate arrangements for mechanically engaging the drone 50 with the docking station 20. In this case, a pair of split-plates 320 are provided, which have a part circular cut-out 322 in them. The split-plates 320 can be pushed together, as shown in FIG. 5, for example by a spring, so that the cut-outs 322 engage the docking formation 52 in the groove 56 below the plate 58. However, as shown in FIG. 6, when the split-plates 320 are retracted, the spacing between the cut-outs 32 exceeds the size of the plate 58, enabling the drone to be released and/or fly away.

FIGS. 7 and 8 of the drawings show alternate configurations for actuating the split-plates 320. In the embodiment shown in FIG. 7, each split-plate 320 is provided with a slotted aperture 324 within which a pin 326 is arranged to slide. The pin 326 is mounted on a rotatable disc 328 such that rotation of the disc 328 pries the split-plates apart 320 as shown by the dotted lines in FIG. 7.

In FIG. 8, a similar configuration is shown, except this time, a cam is provided at the split line of the split-plates 320. By rotating the cams 320, the split-plates 320 can be pried apart thereby enabling the drone to be released.

Although the embodiments shown in FIGS. 5 to 8 of the drawings show a pair of split-plates, this is purely for simplicity in the drawings and it will be appreciated that any number of split-plates may be provided, such as three or four split-plates arranged at 120 or 90 degree, respectively, instances around the centre line of the plate 58.

The electromagnet 34 can be energised (gradually or instantaneously) to temporarily retain the metal plate 58 of the drone 50 against the flat upper wall 30 of the receiver 26, and the locking pins 32 can be extended, by de-energising the solenoids 38, such that the locking pins 32 spring back into engagement with the circumferential grove 56 of the docking formation 52 of the drone.

Now that the drone 50 is fully-supported by the docking station 20, its rotors 62 can be powered off, such that the drone's weight is now supported by, and suspended from, the docking station. The controller 36 can then switch on a charging circuit, which re-charges the drone 50 using the induction coil system 40, 60 previously described. The drone 50 is then ready for use again.

An environment sensing device may be provided, such as a motion sensor within the docking station 20, which detects gradual or sudden changes in conditions. For example, the drone's rotors may be programmed to rotate slowly every now and again to deter nesting birds and/or bats, for example. Additionally, whilst the drone 50 is fully-docked, its rotors may be spun at speed to create a sudden draught to clear out leaves, rubbish or other debris that may have accumulated within the docking station and/or on and/or around the drone.

An autonomous, remote sentry post 100 incorporating three drone system 10 according to the invention is shown in FIG. 9 of the drawings.

The remote sentry post 100 has a central support pole 102, which supports three docking stations 20, each of which has its own drop drone 50 as previously described. The upper surfaces 104 of each of the docking stations 20 is provided with a solar PV panel 106, which is used to charge a battery (not visible), which is housed within the pole 102. The battery is used to power the remote sentry post 100 as well as to recharge the drones 50.

The remote sentry post 100 is fitted with surveillance cameras 110, which are suitably connected to a monitoring system that can deploy/control the drop drones 50 as required. A wireless connection is provided to a remote monitoring station via an antenna 112 mounted atop the pole 102. In addition, all-round floodlighting 114 is provided, as well as an all-round speaker system 116, such that in the event of a possible activation, sirens, PA messages etc. can be broadcast to deter malicious activity. The use of floodlighting (be that visible or IR) can be used to improve the field of view of the cameras 110 and or to provide general lighting for people, vehicles and/or objects nearby.

Referring now to FIG. 10 of the drawings, a drone docking system 10 in accordance with the invention comprises a drone 50 substantially as hereinbefore described, with a docking formation 52 mounted atop its fuselage 54.

The docking formation 52 comprises a dome-shaped elevated part 520, which supports a circular plate 522, which is spaced apart from the fuselage 54 of the drone 50. The diameter of the plate 522 is slightly larger than the upper end of the elevated part 520 so as to form an undercut 524, which forms an abutment surface.

The plate 522 engages with a plurality of hooks 560, which are pivotally mounted, in this embodiment, on a ring 562. In the illustrated embodiment three hooks 560 are shown, although any number of hooks may be provided so long as they are capable of stably supporting the drone 50 when suspended below the docking station. This embodiment shows the ring 562 being affixed to the underside of the docking station (not shown for clarity) and the hooks 560 are free to pivot about the ring 562.

An abutment ring 564 is provided as well, which limits the extent of downward movement 566 of each of the hooks beyond a certain extent. However, each of the hooks is generally free to pivot in an opposite direction 568 as the drone 50 is raised up below the hooks 560 and an outer edge of the plate 522 contacts an underside of each of the hooks. An actuator ring 570 engages each of the hooks 560 radially outwardly of their support ring 562 and thus, by moving the actuator ring 570 down 572, the hooks 560 can be pivoted up in the direction 568.

Referring to FIG. 11 of the drawings, one of the hooks 560 is shown, schematically, in side view and for the purposes of illustration, the actuator ring 570 has been replaced by a linear actuator 570. It will be appreciated that each of the hooks 560 could be actuated by their own linear actuators, or in unison by an actuator ring 570.

In FIG. 11 of the drawings, it can be seen that the hook 560 radially inwardly of the support ring 562 has a curved surface 580, and that the upper edge of the plate 522 of the drone 50 has a Chamfered corner 582. Therefore, as the plate 522 is moved upwardly 584, the outer edge of the plate 582 will bear against the curved surface 580 of the hook 560 and cause it to pivot out of the way about the support ring 562. In doing so, an opposite surface 586 of the hook is moved away from the actuator ring/linear actuator 570 and shall be described herein below.

FIG. 12 shows a sequence involving the docking and un-docking of the drone 50 from the docking station using a mechanical engagement device, as shown in FIGS. 5 and 6 previously. FIGS. 12A-12E show a docking procedure; whereas FIGS. 12F-12I show an undocking procedure. FIG. 12A largely mirrors FIG. 11 albeit after having moved the hook 560 partly.

As can be seen from FIGS. 12A, B and C, as the drone 50 is moved up 584, the outer edge 582 pushes against the curved underside 580 and pivots the hook 560 about the support ring 562.

The plate 522 will continue to move the hook 560 until such time, as shown in FIG. 12C, the plate 522 eventually passes the tip of the hook 560.

When this happens, as shown in FIG. 12D of the drawings, the hook 560 pivots back about the support ring 562 until the curved surface 580 engages the abutment ring 564. Now, as shown in FIG. 12E, when the drone is moved in an opposite direction, i.e. down, the hook engages in the undercut 524 below the plate 522. This results in the engaged position with gravity (g) serving to hold the drone 50 in engagement with the hooks and the hook 560 in engagement with the abutment ring 564. In this configuration, even if the device is completely powered down, the drone is held in position securely by gravity alone and this provides a stable, fail-safe configuration for retaining the drone.

In order to undock the drone from the docking station, a reverse operation is required, and this involves, as shown in FIGS. 12F to 121 of the drawings actuating the actuator ring 570 so as to push 572 downwardly, and radially outwardly of the support ring 562 on the hook 560. This causes the hook 560 to pivot in an opposite direction now, which prises the drone 50 upwardly as the tip of the hook bears upwardly against the underside of the plate 522. As shown in FIG. 12G of the drawings, the hook eventually reaches a position where its tip is at the edge of the plate 522 and any further movement, as shown in FIG. 12H, causes the hook 560 to disengage from the plate 522 enabling the drone 50 to be released.

Finally, as shown in FIG. 121 of the drawings, the actuator ring 570 can be retracted to reset the hook 560 to the start position, as shown in FIG. 11 of the drawings.

An alternative mechanical engagement device is shown in FIGS. 13 and 14 of the drawings, in which the drone 50 has a docking formation 52 as previously described, but this time, it has a set of three rotating hooks, which can engage with, or disengage from, a ring 602 affixed to the docking station (not shown for clarity). Each hook 600 has a shaft portion 604 and a hook portion 606. The hooks 600 are rotatable about an axis of the shaft portion 604 using a mechanism such as that shown in FIGS. 9A and 9B of the drawings, which is contained within the docking formation 52.

The mechanism comprises a master gear 612, which is driven for rotation by a motor (not shown for clarity). The master gear engages with pinion gears 614, which connect to the shaft portion 604 of the hooks 600. As can be seen by comparing FIG. 14A with FIG. 14B, rotation of the master gear 612 in one direction causes the hook portion 606 to move to a radially inwardly facing direction; whereas subsequent rotation, or rotation in an opposite direction, causes the hook portions 606 to face in a radially outward direction.

As can be seen from the lower parts of FIGS. 14A and 14B, when the hooks are in the radially inwardly facing configuration, their outer circumference is less than that of the engagement ring 602, and they can therefore pass up inside the engagement ring 602. However, when the master gear is rotated, the hooks 600 rotate so that their hook portions face outwardly, and thereby have a larger outer diameter than the engagement in 602. This enables the hooks to engage with the engagement ring thereby retaining the drone 50 within the housing (not shown).

As has previously been alluded to, a supplementary restraint system is suitably provided to prevent the drone from falling out of the docking station in the event of a malfunction. An example of a supplementary restraint system is shown in FIGS. 15A to 15D of the drawings.

In FIG. 15A of the drawings, it can be seen that a housing substantially as described with a reference to FIG. 3 has a drone 50 docked with it. If the connection between the docking formation 52 of the drone and the receiver 26 of the docking station 20 fails, then the drone 50 could simply fall out of the docking station 20 causing damage to itself and/or objects and/or people nearby. To safeguard against this, a set of elasticated bands 800 span the lower part of the docking station 20, thereby preventing the drone 50 from falling out of the docking station 20 in the event of such a malfunction.

FIGS. 15B and 15C of the drawings show the docking station of FIG. 15A from below and it can be seen that in FIG. 1013, the elasticated cords 800 have been retracted to such an extent that the drone 50 is able to leave the docking station 20 unimpeded.

The elasticated cords 800 are anchored at their opposite ends 802 to anchor points surrounding the drone, and their mid-points 804 are pulled radially outwardly by retractors 806.

In the ordinary course of events, the retractors 806 pull the elasticated cords 800 out of the way, as shown in FIG. 15A; but in the event of a drone/docking station malfunction, the retractors 806 can be elongated so that the elasticated cords 800 now span the underside of the docking station 20, preventing the drone 50 from falling out of it.

Although the supplementary restraint system illustrated using two elasticated cords 800, it will be appreciated that any suitable number of elasticated cords 800 may be provided in order to ensure safe retention of the drone 50 within the docking station 20 in the event of a malfunction.

FIG. 15D of the drawings shows an alternate retraction mechanism for the elasticated cords 800, which are anchored at their opposite ends 802 as previously described. However, the midpoint 804 is connected to a metal plate 810, which is attracted to an electromagnet 812. When the housing 20 is powered-up, the electromagnet 812 is energised causing the metal plate 810 to securely connect to the electromagnet 812. However, in the event of a power failure, the electromagnet 812 de- energises, thereby releasing the plate 810, and enabling the elasticated cord 800 to adopt the spanning position as shown by the dotted line in FIG. 15C.

In certain embodiments of the invention, the elasticated cord may be used to deploy a catch net. That is to say, the edge of a catch net could be secured to the cord such that when the cord 800 is in the straight configuration, the catch net (not shown) underlies the docking station 20.

The retractors 806 can be actuated by a winch, but in certain embodiments, they may be of a fixed length and held in the retracted position by electromagnets. Therefore, in the event of a power failure, the electromagnets will de-energise, thereby automatically releasing themselves and allowing the elasticated cord 800 to adopt the configuration shown in FIG. 10C of the drawings.

FIG. 16 is a schematic, perspective, partially cut-away view of an embodiment of the docking station 20 from below. The docking station 20 has the part conical-shaped receiver recess 26 previously described, the sidewall of which having the locking pins 32 partially protruding therethrough. Located on the flat wall 261 of the recess 26 is a fiducial marker 260 having a set of machine-readable features on it. The fiducial marker 260 may comprise a barcode, a QR code or symbols (as shown). Due to the location of the fiducial marker 260 of the flat wall 261 of the recess, it is observable by the upward facing camera 50 of the drone 50, as mentioned previously with reference to FIG. 4 above.

FIGS. 17A and 17B illustrate what the upward-facing camera 59 on the drone 50 “sees”. In FIG. 17A, the drone's docking formation 52 is misaligned with the recess, both translationally and rotationally. This can be detected by the lateral and vertical displacement of the fiducial marker's line features relative to an imaginary crosshair 592 in the upward-facing camera's 59 field of view 590. The drone's controller can thus apply flight control inputs to correct the deviation, so that the fiducial marker 290 correctly aligns with the crosshairs 592 in the upward-facing camera's 59 filed of view 590—as shown in FIG. 17B. As such, the provision of one or more fiducial markers 260 placed on the docking station 20 within the field of view 590 of any of the drone's camera's, but in particular, an upward-facing camera 59, can be used to assist the drone 50 in correctly aligning and/or docking with the docking station 20.

The invention is not restricted to the details of the foregoing embodiment, which is merely exemplary of an embodiment of the invention. The scope of protection, however, is determined by the appended claims.

1-28. (canceled)

29. A drone docking system comprising:
(a) a drone comprising a fuselage portion having a docking formation; and
(b) a docking station for the drone, the docking station comprising a receiver for releasably receiving the docking formation, wherein the receiver is located above the docking formation such that when the drone is docked with the docking station, it is suspended by and below the docking station, the and drone docking system further comprising:
(c) a mechanical engagement device operating between the drone and the docking station, which selectively engages/disengages the drone to/from the docking station, the mechanical engagement device comprising one or more solenoid actuated locking pins, which engage a groove extending around a perimeter of the docking formation, the solenoid-actuated locking pin or pins being biased towards a position in which it or they engage the groove, and wherein the solenoid or solenoids are configured to retract the locking pins when they are energized.

30. The drone docking system of claim 1, wherein the mechanical engagement device comprises one or more split plates, which engage a groove extending around a perimeter of the docking formation, the split plates being radially moveable relative to one another between a first position in which they engage a the groove, and a second position in which they disengage from the groove.

31. The drone docking system of claim 2, wherein the split plates are radially biased towards the first position, and wherein means, being any one or more of: a solenoid, a cam, a linear actuator, a rack and pinion, a wedge and a screw thread, is provided to urge the split plates towards the second position.

32. The drone docking system of claim 1, wherein the mechanical engagement device further comprises a catch-type device being:
(a) on a first one of the drone or docking station: a plurality of pivotally mounted hooks, whose range of motion is constrained in a first hook direction by an abutment, but which are free to pivot away from the abutment in a second hook direction opposite to the first hook direction; and
(b) on the other one of the drone or docking station, an abutment, whereby:
(c) the abutment is moveable relative to the hooks by movement of the drone relative to the docking station, such that:
during movement of the abutment in a first drone movement direction, the abutment moves the hooks in the second hook direction to a position whereby they eventually pass by the abutment and the hooks then move in the first hook direction until they engage their respective abutments;
such that upon subsequent movement of the abutment in a second drone movement direction opposite the first drone movement direction, the abutment is engaged by the hooks to engage the drone with the docking station.

33. The drone docking system of claim 4, wherein the first hook direction and the second drone movement direction are substantially in the direction of gravitational force, and wherein they second hook direction and the first drone movement direction are substantially away from the direction of gravitational force.

34. The drone docking system of claim 1, wherein the receiver further comprises an electromagnet and the docking formation comprises a metal plate, wherein, when the electromagnet is energised, it attracts and retains the metal plate of the docking formation thereby supporting the drone below the docking station, but which when de-energised, releases the metal plate of the docking formation, thereby releasing the drone from the docking station.

35. The drone system of claim 1, further comprising means for delaying the release of the drone from the docking station until such time as the drone has generated sufficient lift to support its own weight, the drone docking system comprising: a force-sensing device interposed between the receiver and docking formation, which force-sensing device is adapted to sense the force (weight) imparted by the drone on the docking station; and a controller, wherein the controller is adapted to prevent and/or delay the releasing of the drone from the docking station when it is determined, using the force-sensing device, that the drone is generating insufficient lift to support its own weight.

36. The drone docking system of claim 7, comprising: rotor speed sensor for sensing the speed of the drone's rotor or rotors; and a controller, wherein the controller is adapted to prevent and/or delay the releasing of the drone from the docking station when it is determined, using a known relationship between the drone's rotor speed(s) and the resultant lift force, that the drone is generating insufficient lift to support its own weight.

37. The drone docking system of claim 8, wherein the controller is adapted to control the current in the electromagnet in proportion to a detected or measured lift generated by the drone, such that a transition from docked to free-flight or vice versa is gradual.

38. The drone docking system of claim 8, wherein prior to and during a docking procedure, the electromagnet is energised to create a magnetic field having a magnetic field profile, the magnetic field profile being configured to urge the docking formation into alignment with the receiver.

39. The drone docking system of claim 10, comprising a plurality of independently controllable electromagnets each forming its own magnetic field each having a magnetic field profile; and an electromagnet controller, which is configured to adjust the currents in the electromagnets such that the magnetic field profiles displace the docking formation into alignment with the receiver, the electromagnet controller being configured to displace the docking formation in a vertical and/or a horizontal plane and/or to tilt the docking formation about any one or more of the pitch, yaw and roll axes.

40. The drone docking system of claim 1, wherein the docking station further comprises
(a) a supplementary restraint system, which automatically catches the drone in the event of it inadvertently decoupling from the docking station, the supplementary restraint system comprising
(b) one or more elasticated cords each having:
(i) an extended position in which it/they span at least part of an underside of the docking station at a level below the drone; and
(ii) a retracted position in which it/they are retracted so as to permit the drone to enter/leave the docking station unimpeded or substantially unimpeded;
(c) a retractor for the or each elasticated cord for retaining the or each elasticated cord in the retracted position; and
(d) means for releasing the retractor in the event of the drone inadvertently decoupling from the docking station.

41. The drone system of claim 1, wherein the drone is adapted to carry a payload, the payload being any one or more of the group comprising: a video surveillance camera, which is remotely operable to pan/tilt/zoom in accordance with cameral control instructions; a public address system, which enables a pilot/operator/computer system to broadcast voice and/or pre-recorded messages to people in the vicinity of the drone; a LIDAR scanner; a tracking system; a SmartWater® deployment system, which is able to deposit/spray SmartWater® from the drone onto people or objects below it; and a parachute recovery system.

42. The drone system of claim 1, wherein the docking station comprises an outer housing, which depends downwardly from the docking station to provide a protective curtain around the drone when it is docked and a fairing for directing airflow generated by rotors of the drone smoothly into and/or out of the docking station.

43. The drone system of claim 1, wherein the drone is waterproof, and the density of the drone is less than 1 gcm⁻³, such that the drone floats in water.
